(19) United States
(12) Patent Application Publication
(10) Pub. No.: US 2021/0260907 A1
(43) Pub. Date: Aug. 26, 2021

(54) Kit and Method for Providing Emergency Medical Information

(71) Applicants: Tomasz Piasek, Farmington Hills, MI (US); Colleen Adams, Commerce Twp, MI (US)

(72) Inventors: Tomasz Piasek, Farmington Hills, MI (US); Colleen Adams, Commerce Twp, MI (US)

(21) Appl. No.: 17/186,482

(22) Filed: Feb. 26, 2021

Related U.S. Application Data
(60) Provisional application No. 62/981,622, filed on Feb. 26, 2020.

(51) Int. Cl. B42D 25/28

(52) U.S. Cl. CPC B42D 25/28

(57) ABSTRACT

A kit for providing emergency medical information is shown and described. The kit for providing emergency medical information comprises a medical information card. A medical information envelope is included and is proportioned to accept the medical information card. The kit further includes at least one location card, wherein the location card displays the location of the medical information envelope. Further, the at least one location card may be glow in the dark.

### CROSS REFERENCE TO RELATED APPLICATIONS

This application claims the benefit of U.S. Provisional Application No. 62/981,622 filed on Feb. 26, 2020. The above identified patent application is herein incorporated by reference in its entirety to provide continuity of disclosure.

### BACKGROUND OF THE INVENTION

The present invention relates to providing medical information to emergency medical personnel. More particularly, the present invention provides a kit that will enable a person to safely store and display the location of medical information for emergency medical personnel.

Many individuals have important medical history information that must be consulted before proper medical treatment can be given. Often, in medical emergencies, these individuals do not receive immediate treatment of their particular condition as the emergency responders are often unaware of the patient's medical history. This can prove life-threatening if the medical history is significantly relevant for the proper medical treatment in the emergency situation. In some situations, an individual may wear a medical bracelet. However, there bracelets are limited in size and may not be able to relay all of the necessary information.

Typically, when a patient is suffering from a medical emergency, they are unable to describe their medical history to the emergency responders, often leading to improper or delayed treatment. This improper treatment may result in the issues becoming worse before the person's medical history is discovered. This means that medical costs may be higher. In some circumstances, the situation may be escalated causing further medical issues.

Consequently, there is a need for an improvement in the art of providing emergency medical services. The present invention substantially diverges in design elements from the known art while at the same time solves a problem many people face when needing medical treatment. In this regard the present invention substantially fulfills these needs.

### SUMMARY OF THE INVENTION

The present invention provides a kit for proving medical information wherein the same can be utilized for providing convenience for the user when in need of emergency medical aid. The kit for providing emergency medical information comprises a medical information card. A medical information envelope is included, wherein the medical information envelope is proportioned to accept the medical information card. The kit further includes at least one location card, wherein the location card displays the location of the medical information envelope.

Another object of the kit for providing medical information is to provide location cards that are glow in the dark.

Another object of the kit for providing medical information is to provide location cards that have an adhesive location on a rear side thereof.

Another object of the kit for providing medical information is to provide location cards that have additional emergency information displayed.

Another object of the kit for providing medical information is to provide a medical information envelope that has a magnetic fastener location on a rear side thereof.

Another object of the present invention is to is to provide a method for using an emergency medical information proving kit comprising the steps of filling out the medical information on a medical information card, placing the medical information card in a medical information envelope, and placing the medical information envelope in a secure location.

Another object of the method for using an emergency medical information proving kit includes the step of placing at least one location card around the premises, wherein the location cards display the location of the medical information envelope.

Another object of the method for using an emergency medical information proving kit includes the step of using the medical information card to determine the medical history of a distressed individual.

Another object of the method for using an emergency medical information proving kit includes the step of updating the medical information card.

Another object of the method for using an emergency medical information proving kit is that the secure location is within a refrigerator.

Another object of the method for using an emergency medical information proving kit is that the location cards are designed for specific locations.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the items located within the emergency medical information kit.

FIG. 2 shows a perspective view of an embodiment of the placement of one of the items in the emergency medical information kit.

FIG. 3 shows a perspective view of an embodiment of the placement of the medical information as provided for the emergency medical information kit.

FIG. 4 shows a perspective view of an embodiment of one of the items in the emergency medical information kit that is glow in the dark.

FIG. 5 shows a flow chart for an embodiment of a method of using the emergency medical information kit.

### DETAILED DESCRIPTION OF THE INVENTION

Reference is made herein to the attached drawings. Like reference numerals are used throughout the drawings to depict like or similar elements of the kit and method for providing emergency medical information. For the purposes of presenting a brief and clear description of the present invention, a preferred embodiment will be discussed as used for the kit and method for providing emergency medical information. The figures are intended for representative purposes only and should not be considered to be limiting in any respect.

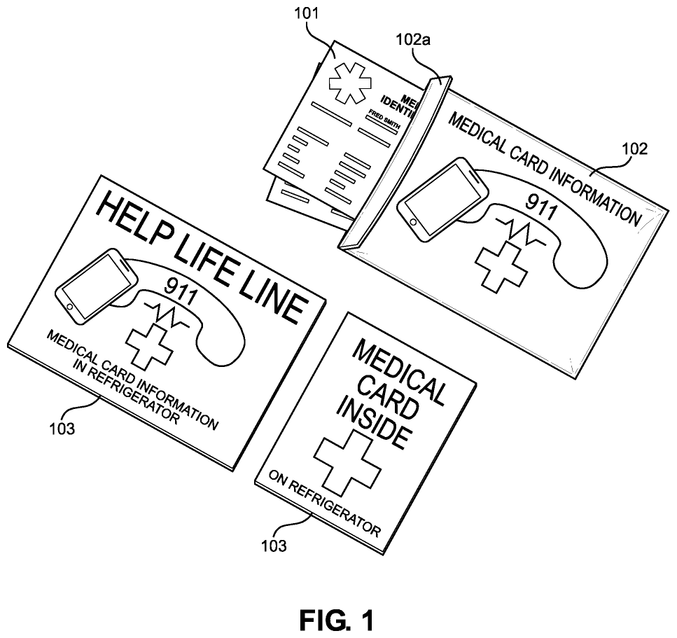

Referring now to FIG. 1, there is shown a perspective view of an embodiment of the items located within the emergency medical information kit. The emergency medical information kit is comprised of an emergency medical information card 101. The emergency medical information card 101 will have the ability to display medical information for one or more individuals. In one embodiment, the medical information is medical history for an individual. In another embodiment the medical information shows prominent medical conditions. In yet another embodiment the medical information shows allergies. In other embodiments other medical information may be shown. In one embodiment the emergency medical information card 101 has first aid information listed on the back of the card.

In one embodiment, the emergency medical information card 101 is configured to allow an individual to hand write their medical information onto the emergency medical information card 101. In one embodiment the emergency medical information card 101 has special headings that prompt a user what information to place on the emergency medical information card 101. In other embodiments information can be printed on the emergency medical information card 101 using a printer.

In one embodiment the emergency medical information card 101 is laminated. In another embodiment the emergency medical information card 101 is water resistant paper. In yet another embodiment the emergency medical information card 101 is configured to have information removed, changed or edited.

The emergency medical information card 101 is proportioned to fit within an emergency medical information envelope 102. The emergency medical information envelope 102 has an interior volume. The interior volume is accessed via an opening on one side. The opening is sealable via an envelope flap 102a. In one embodiment the envelope flap 102a is resealable after opening.

The emergency medical information envelope 102 has in indicia on the front side of the envelope. In one embodiment the indicia display a title of medical information enclosed or a similar informative title. In further embodiments the indicia display a message to call “911.” In yet another embodiment the indicia show more detailed first aid information.

In one embodiment the back side of the emergency medical information envelope 102 has an adhesive located thereon. This will allow the emergency medical information envelope 102 to be adhered to a desired surface. In another embodiment the back side of the emergency medical information envelope 102 has a magnet located thereon. This will allow the emergency medical information envelope 102 to be removably secured to a desired magnetic location.

The emergency medical information kit further includes at least one emergency medical information location card 103. The emergency medical information location card 103 will display the location of the emergency medical information envelope 102. In one embodiment the emergency medical information location card 103 has an adhesive material on the back side thereof. In another embodiment the emergency medical information location 103 card has a magnet location on the backside thereof. Other features of the emergency medical information location card 103 will be discussed below.

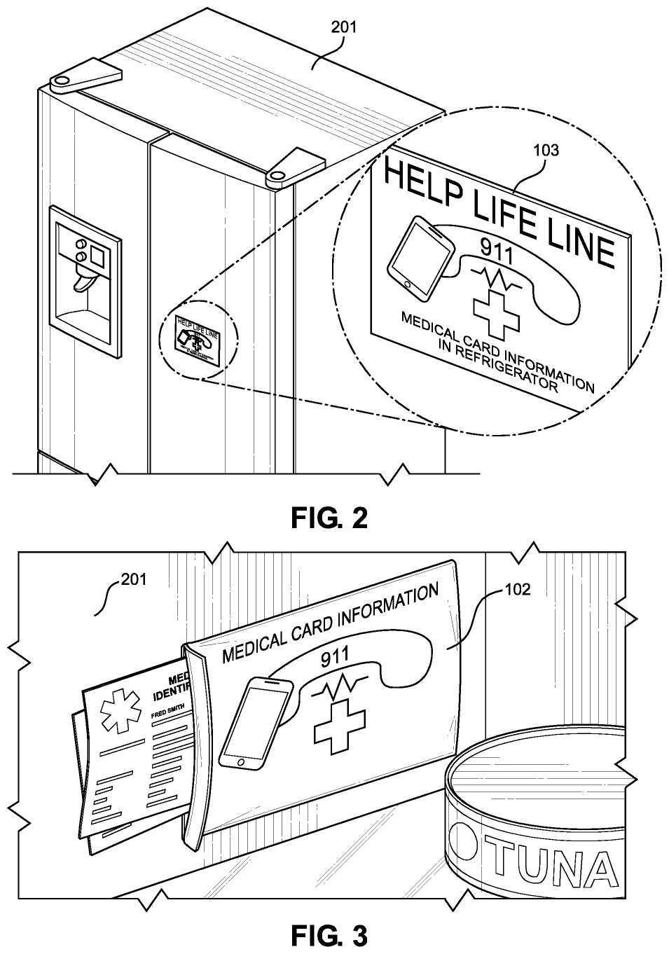

Referring now to FIG. 2, there is shown a perspective view of an embodiment of the placement of one of the items in the emergency medical information kit. In one embodiment one of the emergency medical information location cards 103 is configured to be placed upon a refrigerator 201. The emergency medical information location card 103 will display an indicium thereon. In this embodiment the indicia will read “emergency medical information located inside the refrigerator”. In other embodiments other indicia will be displayed that tells the location of the emergency medical information. For example, in one embodiment the emergency medical information could be in a cabinet. The emergency medical information location card 103 would display medical information in cabinet. In one embodiment the indicia will further inform a user to call 911. In this embodiment this emergency medical information location card 103 is designed to be placed directly on the storage unit for the medical information.

Referring now to FIG. 3, there is shown a perspective view of an embodiment of the placement of the medical information as provided for the emergency medical information kit. In one embodiment the emergency medical information envelope 102 is configured to be placed within a refrigerator 201. In the shown embodiment the emergency medical information envelope is placed upon the wall of the refrigerator 201. In one embodiment the emergency medical information envelope 102 is magnetically secured to the wall of the refrigerator 201. This will allow for easy access to the medical information.

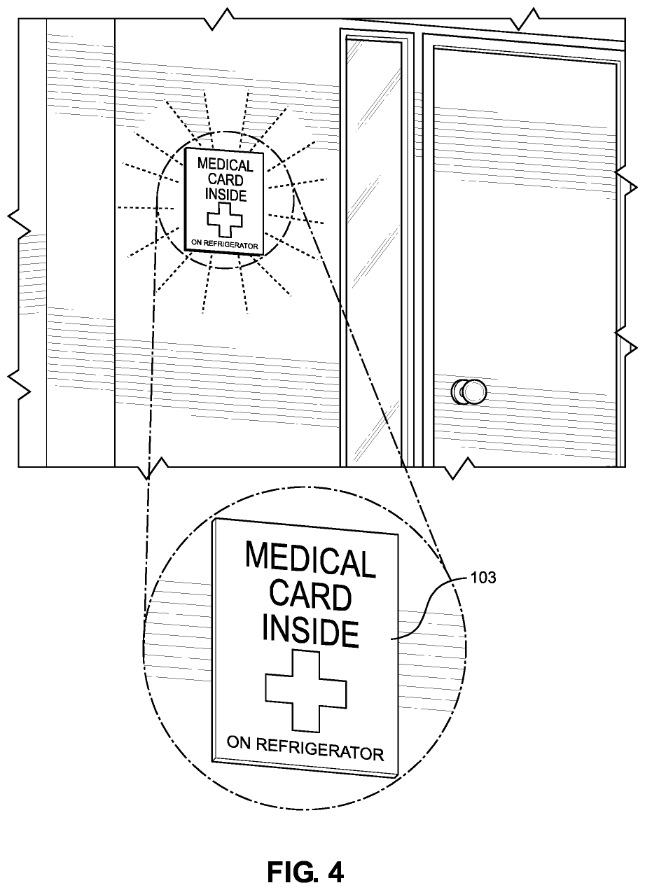

Referring now to FIG. 4, there is shown a perspective view of an embodiment of one of the items in the emergency medical information kit that is glow in the dark. In some embodiments the emergency information location cards 103 are configured to be easily spotted. In some embodiments this means making the emergency information location cards 103 in a bright color. In other embodiments the emergency medical information location cards 103 are made in contrasting colors.

In yet a further embodiment the emergency medical information location cards 103 use luminescent features. In one embodiment the emergency medical information location cards 103 are entirely glow in the dark. In another embodiment only the words printed on the emergency medical information location cards 103 are glow in the dark.

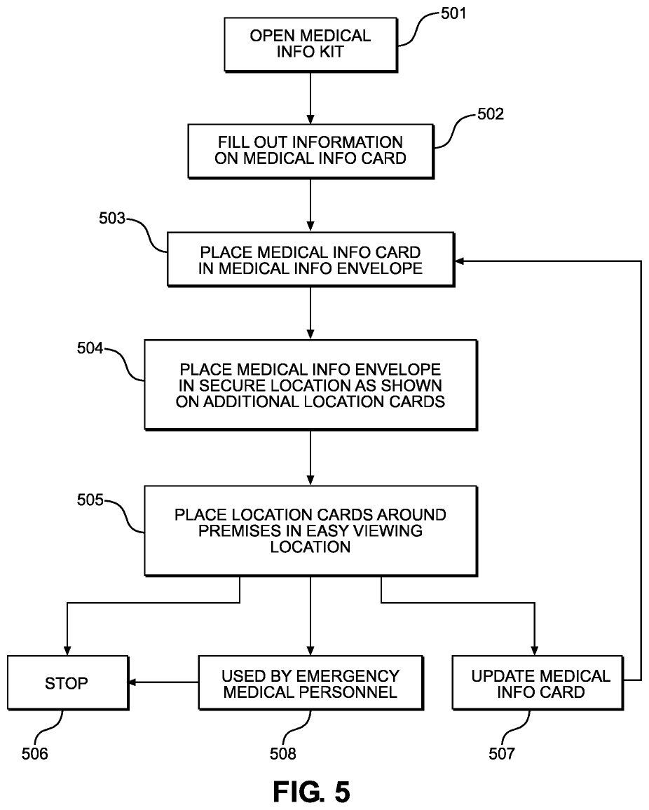

Referring now to FIG. 5, there is shown a flow chart for an embodiment of a method of using the emergency medical information kit. The method for using the emergency medical information kit begins when a user obtains and kit and opens the kit revealing the contents 501. The next step of the process is to fill out the information for the emergency medical information card 502. This process is completed in one of the ways as described in FIG. 1. In other embodiments the emergency medical information card may be filled out in other ways. The emergency medical information card is them placed in the emergency medical information envelope 503.

The emergency medical information envelope is then placed in a secure location 504. In one embodiment the emergency medical information envelope is placed in the location as shown on the emergency medical information location cards. The emergency medical information location cards should then be placed around the premises 505. In different embodiments the steps of placing the information are done in a different order.

After everything is placed the method may be stopped 506. In another embodiment the method continues to update the information on the emergency medical information card as needed 507. In this embodiment the card is then placed back in the emergency medical information card 503. In yet a further embodiment the emergency medical information is used by emergency medical personal to aid them in treating an individual 508. After this the method is stopped 506.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A method for using an emergency medical information proving kit, the method comprising:
filling out the medical information on an emergency medical information card;
placing the medical information card in a medical information envelope;
placing the medical information envelope in a secure location.

2) The method of claim 1, further comprising placing at least one location card around the premises, wherein the location cards display the location of the medical information envelope.

3) The method of claim 1, further comprising using the medical information card to determine the medical history of a distressed individual.

4) The method of claim 1, further comprising updating the medical information card.

5) The method of claim 1, wherein the secure location is within a refrigerator.

6) The method of claim 2, wherein the location cards are designed for specific locations.

7) The method of claim 1, further comprising opening the medical information kit.

8) A kit for providing emergency medical information, the kit comprising:
a medical information card;
a medical information envelope, wherein the medical information envelope is proportioned to accept the medical information card;
at least one location card, wherein the location card displays the location of the medical information envelope.

9) The kit for providing medical information of claim 8, wherein the location cards are glow in the dark.

10) The kit for providing medical information of claim 8, wherein the location cards have an adhesive location on a rear side thereof.

11) The kit for providing medical information of claim 8, wherein the location cards have additional emergency information displayed.

12) The kit for providing medical information of claim 8, wherein the medical information envelope has a magnetic fastener location on a rear side thereof.

13) A kit for providing emergency medical information, the kit consisting of:
a medical information card;
a medical information envelope, wherein the medical information envelope is proportioned to accept the medical information card;
two location cards, wherein each location card displays the location of the medical information envelope.

14) The kit for providing medical information of claim 13, wherein the location cards are glow in the dark.

15) The kit for providing medical information of claim 13, wherein the location cards have an adhesive location on a rear side thereof.

16) The kit for providing medical information of claim 13, wherein the location cards have additional emergency information displayed.

17) The kit for providing medical information of claim 13, wherein the medical information envelope has a magnetic fastener location on a rear side thereof.
